(19) United States
(12) Patent Application Publication
(10) Pub. No.: US 2004/0240994 A1
(43) Pub. Date: Dec. 2, 2004

(54) Fan housing

(76) Inventors: Eric S. Cole, St. Charles, IL (US); William J. Metzger, Crystal Lake, IL (US); Ling-Zhong Zeng, Lake in the Hills, IL (US); Michael J. Roman, Elgin, IL (US); Michael F. Buckley, McHenry, IL (US)

Correspondence Address: MICHAEL BEST & FRIEDRICH, LLP, 100 E WISCONSIN AVENUE, MILWAUKEE, WI, 53202, US

(21) Appl. No.: 10/789,929

(22) Filed: Feb. 27, 2004

Related U.S. Application Data
(60) Provisional application No. 60/450,718, filed on Feb. 28, 2003.

(51) Int. Cl. F03D 11/00

(52) U.S. Cl. 415/215.1

(57) ABSTRACT

Some embodiments of the present invention provide a two-piece fan housing having a seam between first and second housing pieces. In some embodiments, a portion of the seam extends circumferentially about the fan housing while also extending axially. Also, some embodiments of the present invention provide an integrally-formed intake wall at or adjacent the fan housing intake aperture and extending axially into the fan housing. The axially extending intake wall can also extend radially inwardly to define an inlet restriction of the fan housing.

### CROSS-REFERENCE TO RELATED APPLICATION

Priority is hereby claimed to co-pending U.S. Provisional Patent Application No. 60/450,718 filed on Feb. 28, 2004, the entire contents of which are incorporated herein by reference.

### FIELD OF THE INVENTION

This invention relates generally to fan housings, and more particularly to fan housings constructed of two or more fan housing parts.

### BACKGROUND OF THE INVENTION

Fans are employed in a variety of applications to move air and other fluids to different locations. By way of example only, fans are often utilized in furnaces to exhaust heated air and fumes from the furnace. Conventional fans often include a sheet metal housing supporting a fan wheel. In many cases, the sheet metal housing also supports an electric motor connected to the fan wheel. Sheet metal is often used to manufacture the fan housings for a number of reasons, such as for economic reasons (i.e., casting fan housings is usually more expensive than stamping fan housings from sheet metal) or for environmental reasons (i.e., fan housings must often withstand temperatures and conditions that are not suitable for fan housings made from plastic or other materials).

For manufacturing purposes, conventional fan housings are often assembled from two or more stamped pieces. This allows the fan wheel to be inserted between the stamped pieces during assembly of the fan. Subsequently, the electric motor or other driving unit is coupled to the fan wheel. In some cases, the electric motor or other driving unit is mounted to the fan housing to finalize assembly of the fan. Alternatively, the fan housing can sometimes be assembled around a fan wheel without disturbing the connection between the fan wheel and an electric motor or other driving unit.

The exhaust port of conventional fans is typically rectangular for manufacturing and economic reasons. Forming a rectangular exhaust port section from a two-piece fan housing usually requires a less complex housing design, and subsequently a less complex manufacturing process (which is often directly related to the manufacturing cost of the fan). However, pipe or ducts that connect to the exhaust port of the fan and that route the air, fumes, and other fluids away from the fan is often circular in cross-sectional shape. As a result, a transition piece separate from the fan is often required to adapt the rectangular exhaust port to the circular exhaust pipe. Manufacturing this transition piece and assembling it to the fan can add to the overall manufacturing cost of the fan and can make the fan assembly and connection process more difficult and time consuming.

As discussed above, it is often necessary to manufacture fans from metal (such as sheet metal). This need presents certain limitations in the manufacturing process. In particular, it is often more difficult to form, stamp, or otherwise manufacture fan housing parts from metal than from many other materials (such as plastic and other synthetic materials). Some forms that can be generated by molding a housing part in plastic cannot be generated by stamping the same housing part in metal without generating unsatisfactory results.

For example, conventional fan housings are often assembled from two or more mating portions of sheet metal, such as two mating fan housing halves. This practice positions a seam between the housing halves near the middle or bottom of the fan (with reference to the location of the seam along the axis of rotation of the fan wheel). Mating flanges on each sheet metal half often comprise the seam. These flanges are typically secured together by crimping or welding, by fasteners, or in other conventional manners. Since the mating flanges are positioned toward the center of the fan, a mounting bracket, tube, or other intermediate device separate from the fan is often required to mount the fan to the furnace. Like the transition piece, manufacturing the mounting bracket and assembling it to the fan adds to the overall manufacturing cost and to the time needed to install the fan. Alternatively, other provisions must be made to connect such fan housing flanges to an adjacent structure.

### SUMMARY OF THE INVENTION

Some embodiments of the present invention provide a fan housing for a fan rotatable about an axis, wherein the fan housing comprises: a first housing component at least partially defining an internal chamber adapted to receive the fan, and an inlet wall having an inlet aperture through which fluid enters the fan housing, the first housing component comprising a transition section extending away from the inlet aperture toward an exhaust outlet and through which fluid passes from the internal chamber to the exhaust outlet, an axially-extending side wall located adjacent the exhaust outlet, and a wall integrally formed with the inlet wall, running around the inlet aperture, and extending generally axially into the internal chamber; a second housing component complementary to the first housing component and at least partially defining the internal chamber, the second housing component comprising a transition section extending toward the exhaust outlet and through which fluid passes from the internal chamber to the exhaust outlet, and a side wall extending axially toward the first housing component and shaped complementary to the axially-extending side wall of the first housing component; and a housing seam defined between the side wall of the first housing component and the side wall of the second housing component, the seam having a length extending at least partially about the axis while extending axially.

In some embodiments, a two-piece fan housing for receiving a fan rotatable about an axis is provided, and comprises a first housing piece comprising a first wall, an inlet aperture defined in the first wall through which fluid enters the fan housing, and a transition section extending to and partially defining an exhaust outlet of the fan housing through which fluid exits the fan housing; a second housing piece shaped complementary to the first housing piece and comprising a second wall spaced from the first wall, and a transition section extending to and partially defining the exhaust outlet; a side wall extending about the axis between the first and second walls of the first and second housing pieces, the side wall comprising an axial length between the first and second walls, at least a majority of the axial length of the side wall adjacent to the exhaust outlet defined by the first housing piece, and at least a majority of the axial length of the side wall in other locations around the axis defined by the second housing piece; and a seam defined between adjacent portions of the first and second housing pieces, the seam running about the axis, comprising a first portion running partially about the axis while also running in an axial direction, and further comprising a second portion lying within a plane substantially perpendicular to the axis, wherein the first and second portions of the seam are joined by an axially-curved third portion of the seam integral with the first and second portions.

Some embodiments of the present invention provide a method of manufacturing a two-piece fan housing for receiving a fan rotatable about an axis, wherein the method comprises: forming a first wall from a first substantially flat sheet of material; forming an inlet aperture in the first wall; forming an axially-extending inlet wall from the first substantially flat sheet of material, the axially-extending inlet wall running about the inlet aperture; forming a first transition section from the first substantially flat sheet of material, the first transition section extending to and partially defining an exhaust outlet of the fan housing; forming a first portion of a volute housing side wall from the first substantially flat sheet of material; forming a second wall from a second substantially flat sheet of material; forming a second transition section from the second substantially flat sheet of material, the second transition section extending to and partially defining the exhaust outlet; forming a second portion of a volute housing side wall from the second substantially flat sheet of material, the second portion of the volute side wall having a shape complementary to the first portion of the volute housing side wall; and coupling the first and second portions of the volute housing side wall together along a seam that extends axially while also extending circumferentially.

Further objects and advantages of the present invention, together with the organization and manner of operation thereof, will become apparent from the following detailed description of the invention when taken in conjunction with the accompanying drawings, wherein like elements have like numerals throughout the drawings.

### BRIEF DESCRIPTION OF THE DRAWINGS

In the drawings, wherein like reference numerals indicate like parts:

FIG. 1 is a top perspective view of a fan housing according to an exemplary embodiment of the present invention;

FIG. 2 is a bottom perspective view of the fan housing of FIG. 1;

FIG. 3 is a bottom perspective view of a inlet-side component of the fan housing of FIG. 1;

FIG. 4 is a top perspective view of a drive-side component of the fan housing of FIG. 1;

FIG. 5 is an exploded perspective view of the fan housing of FIG. 1, illustrating interior surfaces of the drive-side component and inlet-side component;

FIG. 6 is a front view of the fan housing of FIG. 1;

FIG. 7 is a right side view of the fan housing of FIG. 1;

FIG. 8 is a left side view of the fan housing of FIG. 1;

FIG. 9 is a perspective view of an inlet-side component of a fan housing according to another embodiment of the present invention;

FIG. 10 is a perspective view of an inlet-side component of a fan housing according to yet another embodiment of the present invention; and

FIG. 11 is another perspective view of the inlet-side component of FIG. 10.

Before the various embodiments of the present invention are explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that phraseology and terminology used herein with reference to device or element orientation (such as, for example, terms like “front”, “back”, “up”, “down”, “top”, “bottom”, and the like) are only used to simplify description of the present invention, and do not alone indicate or imply that the device or element referred to must have a particular orientation. The fan housing of the present invention can be installed and operated in any orientation desired.

### DETAILED DESCRIPTION

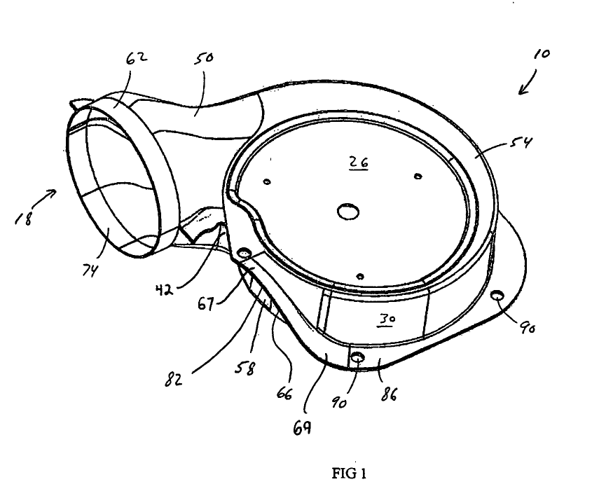

With reference to FIGS. 1-2 and 5-8, a two-piece fan housing 10 is shown. The fan housing 10 includes a first opening defining an intake port 14, and a second opening defining an exhaust port 18. With reference to planes in which the first and second openings lie, the intake port 14 is substantially perpendicular to the exhaust port 18 in some embodiments. In other embodiments, the intake and exhaust ports 14, 18 can be at any angle with respect to one another. By way of example only, the exhaust port 18 can be located above the housing (as viewed in FIG. 1) and can lie in a plane parallel or at an acute angle with respect to the intake port 14. Such an orientation is possible, for example, by extending the exhaust transition in the illustrated embodiment through a 90 degree upward turn or an upward turn. Other turns of different degrees are also possible. Any other intake and exhaust port positional relationship is possible and falls within the spirit and scope of the present invention.

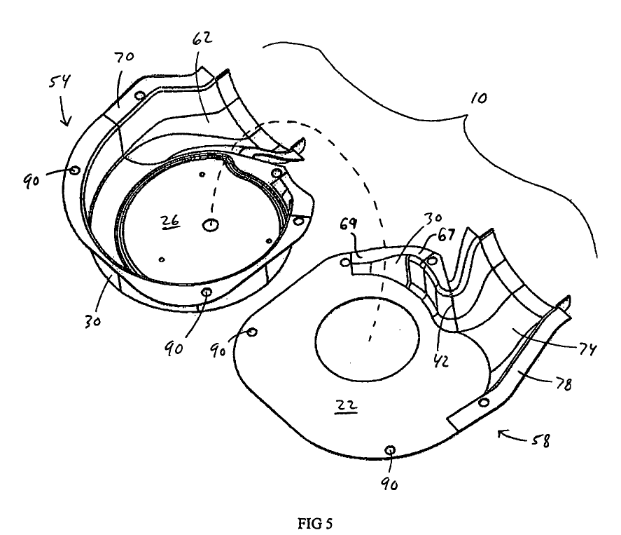

Generally, a centrifugal fan (not shown) positioned in the housing 10 draws air (or other gases or fluids) through the intake port 14, and subsequently expels the air (or other gases or fluids) through the exhaust port 18. As shown in FIG. 5, the fan housing 10 generally includes a bottom wall 22, a top wall 26, and a side wall 30 connecting the bottom and top walls 22, 26. The fan housing 10 generally defines a scroll shape. In particular, a fluid passage is defined in the fan 10 between a side wall 30 of the fan housing and the outer periphery of the fan (not shown), and extends from a cutoff 42 beside the exhaust port 18, around the fan, and to the exhaust port 18. As is well known in the art, the cutoff 42 is shaped to substantially regulate the amount of air re-circulating through the fan housing 10. The scroll extending from the cutoff 42 to the exhaust port 18 in the illustrated embodiment is defined and at least partially enclosed by the side wall 30, the top wall 26, the bottom wall 22 and the outer periphery of the fan (not shown).

With reference to FIGS. 1, 7, and 8, the housing 10 includes a transition section 50 in which the cross-sectional shape of the housing 10 changes toward the exhaust port 18. In other embodiments of the present invention (not shown), the housing 10 has no transition section as just described, such that the cross-sectional shape of the housing remains substantially constant to the exhaust port. In such embodiments, the exhaust port can have a similar cross-sectional rectangular shape as the cross-sectional shape of the scroll upstream of the exhaust port, and may or may not have a different size than the cross-sectional shape of the scroll in such upstream locations.

In some embodiments (such as that shown in the figures), a plane substantially parallel to the axis of rotation of the fan wheel passed through the fan housing 10 in an orientation perpendicular to the direction of flow toward the exhaust port 18 generates a rectangular cross sectional shape as just described. In those embodiments of the present invention having a transition section as described above, as this plane is moved closer to the exhaust port 18 along the transition section 50, this cross-sectional shape changes from being rectangular at the entrance of the transition section 50 to being round at the exhaust port 18. In other embodiments, the cross-sectional shape of the fan housing 10 changes in other manners through the transition section 50, and can lead to a rectangular shape, an oval shape, an irregular shape, or any other desired shape at the exhaust port 18.

With reference again to the illustrated exemplary embodiment, in some embodiments the cross-sectional shape of the scroll is blended from being generally rectangular upstream of the transition section 50 to round at the exhaust port 18. The transition section 50 then leads into the generally round exhaust port 18 as discussed above. The exhaust port 18 includes a diameter appropriately sized to engage conventional exhaust pipe (not shown) to route fluids (e.g., air or other gasses, etc.) away from the fan housing 10.

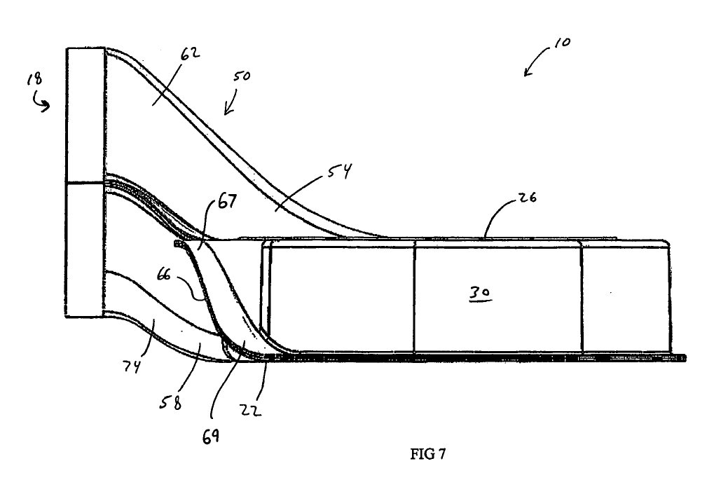

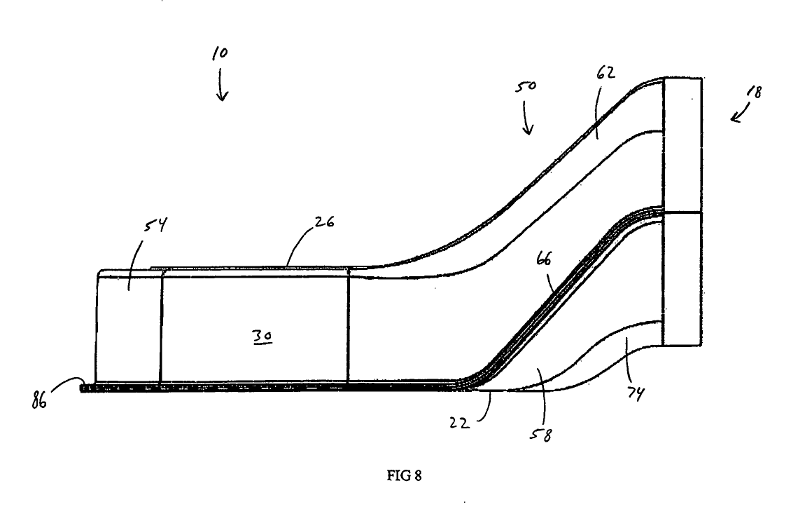

In some embodiments, the exhaust port 18 is axially offset with respect to the rest of the fan housing 10. In other words, the center of the exhaust port 18 is offset a distance along the axis of rotation of the fan wheel (i.e., from a plane perpendicular to the axis and passed through the middle of the housing portion containing the fan wheel). This offset can be in either direction—toward or away from the intake port 14. By way of example, and as most clearly shown in FIGS. 7 and 8, the transition section 50 in the illustrated embodiment is shaped to elevate the exhaust port 18 relative to the bottom-most surface of the fan housing 10. This allows the exhaust pipe to be engaged with the exhaust port 18 without interference from a surface to which the fan is attached (e.g., a frame or wall of a furnace).

In other embodiments of the present invention (not shown), the exhaust port 18 is not axially offset with respect to the rest of the fan housing 10. In such embodiments, the center of the exhaust port 18 can lie in a plane perpendicular to the axis of rotation of the fan wheel (not shown) and passing through the middle of the housing portion containing the fan wheel. Also, in still other embodiments of the present invention (not shown), the exhaust port 18 is not offset with respect to the fan housing 10 having no transition section as described above.

In some embodiments (such as in the exemplary illustrated embodiment), the fan housing 10 is formed from two portions: a drive-side component 54 and an inlet-side component 58. As used herein, the term “component” should be interpreted as being part of a whole, whereby individual components of the housing 10 can be used in combination to form a unit. However, it should be noted that the present invention is not limited to fan housings 10 comprised of two components. In other embodiments (not shown), the fan housing 10 is formed from any number of pieces. By way of example only, either the drive-side component 54, inlet-side component 58, or both drive-side and inlet-side components 54, 58 in the illustrated embodiment can be further defined by multiple pieces.

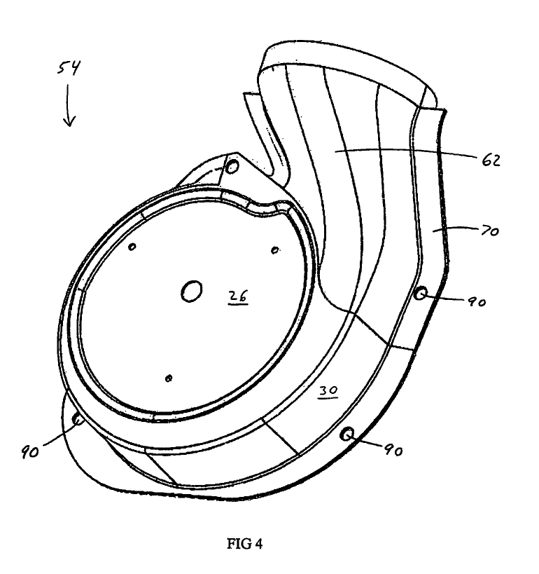

In the exemplary embodiment shown in FIGS. 1-8, the drive-side component 54 is the component of the fan housing 10 facing away from the upstream equipment (e.g., furnace or other device from which the fan receives air, gasses, or other fluids being moved), and the inlet-side component 58 is the component of the fan housing 10 facing toward the upstream equipment. As will be discussed in greater detail below, the inlet-side component 58 can include, among other housing parts, the bottom wall 22, an inlet-side transition portion 74 (described in greater detail below), and at least a portion of the side wall 30. In some cases, the inlet-side component 58 is mounted to the upstream equipment, thereby providing a manner in which to mount the fan housing 10. As best shown in FIGS. 1 and 4-8, the drive-side component 54 in the illustrated embodiment includes the top wall 26 and defines a portion of the side wall 30 extending from the top wall 26. The top wall 26 can provide a mounting surface for an electric motor (not shown), which includes an output shaft (also not shown) passing through the top wall 26 and coupling to the centrifugal fan. The transition section 50 is defined in part by a portion of the drive-side component (a drive-side transition portion 62).

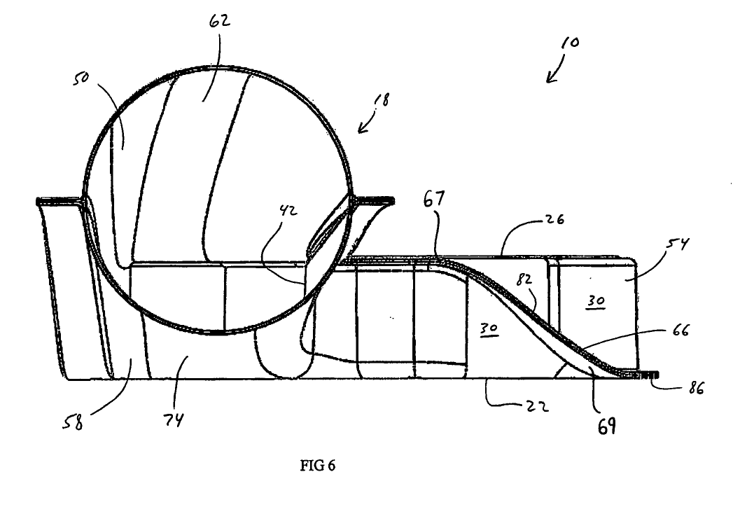

With continued reference to the drive-side component 54 as best shown in FIGS. 1 and 4-8, the portion of the housing side wall 30 defined by the drive-side component 54 extends around the housing 10 from the exhaust outlet 18, and terminates prior to reaching the cutoff 42. As can be seen in FIG. 6, the portion of the side wall 30 defined by the drive-side component 54 reduces in height until the housing side wall 30 is entirely (or substantially entirely) defined by the inlet-side component 58. In other words, the side wall 30 defined by the drive-side component 54 changes proportionally with that of the side wall 30 defined by the inlet-side component 58. This transition can define a seam 66 between the drive-side and inlet-side components 54, 58 that is substantially diagonal as shown in FIG. 6, whereby the portions of the drive-side and inlet-side components 54, 58 defining the side wall 30 gradually change toward the transition section 50 as less of the housing side wall 30 is defined by the drive-side component 54 and more of the side wall 30 is defined by the inlet-side component 58.

One aspect of the present invention is the relationship between a plane substantially perpendicular to the axis of rotation of the fan and the seam 66 between the drive-side and inlet-side components 54, 58 of the housing 10. In conventional fan housings, the seam between drive-side and inlet-side components lies in a plane that is substantially perpendicular to the axis of rotation of the fan. In some embodiments of the present invention however, the seam 66 is not located in a single plane, or is located in a plane that is not perpendicular to the axis of rotation of the fan. In either case, the resulting side wall 30 is defined by different amounts of the drive-side and inlet side components 54, 58 at different circumferential locations of the sidewall 30.

With reference to the illustrated embodiment by way of example only, the seam 66 in the housing 10 between the cutoff 42 and the beginning of the transition section 50 lies not in a single plane, but in multiple planes at different elevations along the axis of rotation of the fan. In the illustrated embodiment, the seam (between the cutoff 42 and the beginning of the transition section 50) lies primarily in two planes: one plane that is co-planar or substantially co-planar with the top wall 26, and one plane that is co-planar or substantially co-planar with the bottom wall 22, both such portions being connected by a diagonally-disposed portion of the seam 66. In those cases where the seam 66 lies primarily in two different planes (e.g., two parallel planes) as just described, these planes need not necessarily be located along the axis of the fan in the positions illustrated in the figures. Instead, the portions of the seam 66 located in the different planes can be located anywhere in the sidewall along the axis of the fan 10 while still being in different planes and being separated by a diagonal, stepped, or other seam portion. For example, the portion of the seam 66 in the illustrated embodiment that is located at the bottom of the housing 10 (with reference to FIGS. 1 and 6-8) can instead be located at a higher elevation, and/or the portion of the seam 66 at the top of the housing 10 (with reference again to FIGS. 1 and 6-8) can instead be located at a lower elevation. In still other embodiments, any part or all of the seam 66 between the cutoff 42 and the beginning of the transition section 50 can lie in a plane that is non-perpendicular to the axis of rotation of the fan.

In some embodiments of the fan housing 10 comprising two or more pieces (not shown), the fan housing 10 can be described as having a drive-side component 54 and an inlet-side component 58 as described above. In such embodiments, the inlet-side component 58 includes a bottom wall 22 and a side wall 30 upstanding from the bottom wall 22, whereby the side wall 30 of the inlet-side component 58 wraps around only a portion of the outer perimeter of the fan housing 10. The remaining portion of the outer perimeter of the fan housing 10 is comprised of a side wall 30 extending from a top wall 26 of the drive-side component 54.

In some embodiments of the fan housing 10 comprising two or more pieces (not shown), the fan housing 10 can be described as having a drive-side component 54 and an inlet-side component 58 as described above. In such embodiments, an intake port 14 is formed in the inlet-side component 58, and an exhaust port 18 is formed by a combination of the drive-side and inlet-side components 54, 58. A side wall 30 extends around the outer perimeter of the fan housing 10, and a cutoff 42 is defined along the side wall 30 at a portion of the side wall 30 near the exhaust port 18. In such embodiments, the side wall 30 has a first end located on one side of the exhaust port 18, and a second end located on the opposite side of the exhaust port. In the vicinity of the cutoff 42, the side wall 30 is at least partially defined by the inlet-side component 58 of the housing 10, while in the remaining portions of the side wall 30, the side wall 30 is defined by the drive-side component 54 of the housing 10.

As described in another manner, in some embodiments of the fan housing 10 comprising two or more components 54, 58, the fan housing 10 can be described as including a drive-side component 54 and an inlet-side component 58 as described above, whereby an intake port 14 is formed in the inlet-side component 58 and an exhaust port 18 is formed by a combination of the drive-side and inlet-side components 54, 58. A side wall 30 extends around the outer perimeter of the fan housing 10, and a cutoff 42 is defined along the side wall 30 at a portion of the side wall 30 near the exhaust port 18. In such embodiments, a side of the inlet-side component 58 opposite the exhaust port 18 is substantially flat and planar, while the side of the inlet-side component 58 adjacent to the exhaust port 18 defines at least a portion of the side wall 30 in the vicinity of the cutoff 42. As discussed above, in other embodiments the portion of the side wall 30 defined by the inlet-side component 58 can be larger or smaller (i.e., extending more or less about the periphery of the fan housing 10).

As described in greater detail above, in some embodiments the side wall 30 of the housing 10 adjacent to the cutoff 42 is defined at least in part by the inlet-side component 58 of the housing 10, while the portion of the side wall 30 extending around the remainder of the perimeter of the housing 10 is defined by part of the drive-side component 54. In some embodiments, a majority of that portion of the side wall 30 adjacent the cutoff 42 is defined the inlet-side component 58. In other embodiments, at least 75% of that portion of the side wall 30 (e.g., 75% of the height of the wall 30) adjacent the cutoff 42 is defined by the inlet-side component 58. In still other embodiments, the portion of the side wall 30 at the cutoff 42 defined by the drive-side component 54 is no greater than two material thicknesses of the top wall 26, with the remainder of the side wall 30 at the cutoff 42 being defined by the inlet-side component 58. In still other embodiments, substantially the entire side wall 30 adjacent the cutoff 42 is defined by the inlet-side component 58.

In some embodiments, a flange 70 extends from the portion of the side wall 30 defined by the drive-side component 54 and around the outer periphery of the drive-side component 54. This flange 70 can extend in any manner desired, and in some cases can extend substantially perpendicular from the side wall 30 of the housing. The flange 70 extends from the side wall 30 and continues alongside the drive-side transition portion 62. However, near the cutoff 42, the flange 70 extends toward the top wall 26. In some embodiments, the flange 70 is co-planar with the top wall 26 in the vicinity of the cutoff 42 (as best shown in the exemplary embodiment of FIGS. 1-8). Also, in some embodiments the flange 70 continues past the cutoff 42 and along the drive-side transition portion 62 of the drive-side component 54.

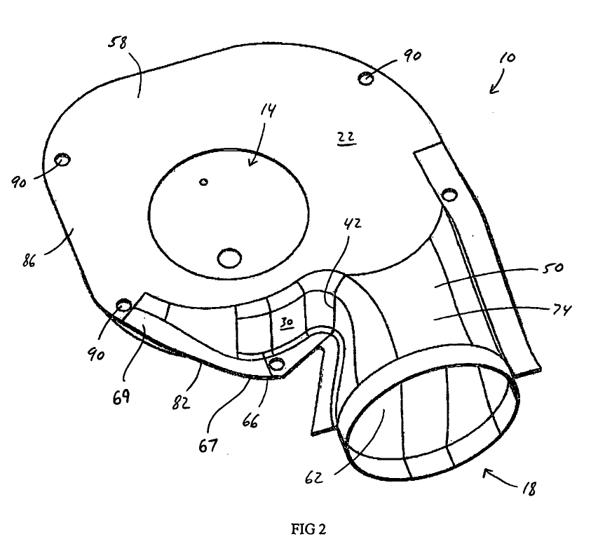

The inlet-side component 58 of the exemplary fan housing 10 is most clearly shown in FIGS. 2-3 and 5-8. The inlet-side component 58 includes the substantially flat bottom wall 22 through which the intake port 14 is defined. In some alternative embodiments, at least a portion of the bottom wall 22 is embossed for increased performance, such as at the perimeter of the fan wheel (not shown) and extending in a direction of the exhaust port 18. In such cases, such embossing can change the height of the side wall 30 and/or can change the shape of the cutoff 42. Near the cutoff 42, a portion of the side wall 30 extends upwardly from the bottom wall 22. The portion of the side wall 30 defined by the inlet-side component 58 and the bottom wall 22 are adjacent the transition section 50 of the housing 10. In some embodiments (such as that illustrated in FIGS. 1-8), the inlet-side component 58 defines at least part of the transition section 50, and therefore has an inlet-side transition portion 74, such that the combination of the drive-side and inlet-side transition portions 62, 74 yield the transition section 50. In the illustrated exemplary embodiment, the cutoff 42 is defined by the blended intersection of the portion of the side wall 30 on the inlet-side component 58 and the inlet-side transition portion 74, although in some embodiments (not shown) the cutoff can also be defined by a portion of the drive-side component (such as in those cases where the above-described seam between the drive-side and inlet-side components does not extend fully to the top wall of the housing at the cutoff).

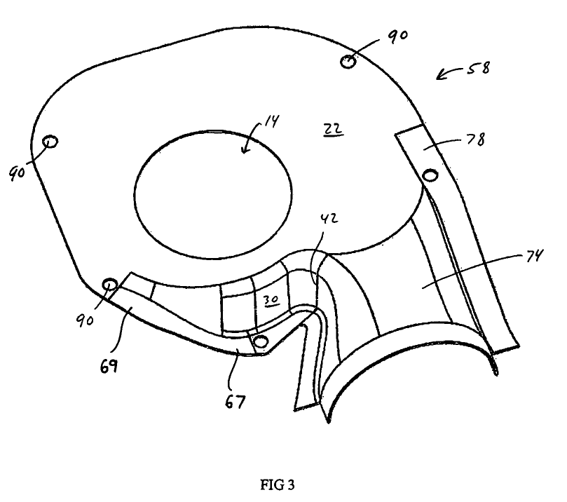

In some embodiments, the outer periphery of the inlet-side component 58 defines a flange 78 which extends around at least a portion of the bottom wall 22. The flange 78 can also continue along the portion of the side wall 30 defined by the inlet-side component 58 (as described above) and alongside the inlet-side transition portion 74 as shown in FIGS. 2 and 3. Like the flange 70 on the drive-side component 54, the flange 78 on the inlet-side component 58 can extend in any direction desired, such as substantially perpendicular from the portion of the side wall 30 defined by the inlet-side component 58 and the inlet-side transition portion 74 as illustrated.

The flanges 70, 78 of the drive-side and inlet-side components 54, 58 can correlate with the general contour of the side wall 30 of the housing 10. When mated, the flanges 70, 78 generally define the seam 66 around the outer periphery of the fan housing 10. Regardless of whether the drive-side and inlet-side components 54, 58 have flanges 70, 78 as described above, a seam 66 can be defined between the drive-side and inlet-side components 54, 58.

In the above-described embodiments having at least a portion of the side wall 30 being defined by the inlet-side component 58, the side wall 30 transitions from a first portion in which substantially the entire height of the side wall 30 is defined by the drive-side component 54 to a second portion in which at least a majority of the height of the side wall 30 (and in some cases, substantially the entire height of the side wall 30) is defined by the inlet-side component 58. The portion of the side wall 30 in which this transition is made (referred to below as the “seam transition 82”), is substantially diagonal in the illustrated embodiment. In other words, in the exemplary embodiment of FIGS. 1-8, the seam 66 transitions substantially diagonally upward from the bottom wall 22 of the inlet-side component 58 toward the top wall 26 of the drive-side component 54. In other embodiments (not shown), the seam transition can occur in any number of ways, including but not limited to, a stepped seam transition 82, a seam transition 82 that is steeper or shallower than the illustrated seam transition 82 (in which case the seam transition 82 can extend along more or less of the side wall 30), a curved seam transition 82, or even a seam transition that extends perpendicularly or almost perpendicularly with respect to the plane of the top wall 26 and/or bottom wall 22.

With reference to FIG. 6, the seam transition 82 of the illustrated exemplary embodiment has a diagonal portion as described above, and is integral with portions of the seam 66 on either side of the seam transition 82. In some embodiments, the diagonal portion of the seam 66 is connected to adjacent portions of the seam 66 by curved seam portions 67, 69 rather than by being connected at sharp angles. In this manner, the seam 66 (and flanges 70, 78, where employed) forms a relatively gently-curving seam shape 66 between that portion of the seam 66 located near a plane of the intake port 114 to the diagonal portion of the seam transition 82, and/or between the diagonal portion of the seam transition 82 and that portion of the seam 66 adjacent the cutoff 42. This curved transition of the seam 66 to and from the seam transition 82 can improve performance of the fan housing 10, and can provide advantages in manufacturing the inlet-side and drive-side components 58, 54.

Although the seam transition 82 in the exemplary illustrated embodiment is located near the cutoff 42 as described above (i.e., at a side of the housing 10 adjacent the exhaust port 18), the seam transition 82 can occur anywhere along the side wall of the housing 30. By way of example only, in other embodiments (not shown) the seam transition 82 can be located immediately adjacent (i.e. terminating at) the cutoff 42, or can be located at a portion of the side wall 30 far from the cutoff 42 (e.g., at a side of the fan housing 10 opposite the exhaust port 18).

As suggested above, in some embodiments the seam transition 82 can extend over a relatively short portion of the side wall 30, or can extend over a longer portion than that illustrated in the figures. For example, in the exemplary embodiment of FIGS. 1-8, the seam transition 82 spans the side wall 30 over a relatively short distance at a side of the housing 10. In such embodiments, the seam transition 82 spans between ⅛ and ⅓ of the outer periphery or circumference of the fan housing 10. In other embodiments (not shown), the seam transition 82 extends along ⅓ to ½ of the outer periphery or circumference of the fan housing 10. In still other embodiments (not shown), the seam transition 82 extends over more than ½ (but less than all) of the outer periphery or circumference of the fan housing 10.

In those embodiments employing flanges 70, 78 on the drive-side and inlet-side components 54, 58 as described above, the drive-side component 54 and the inlet-side component 58 are mated via the flanges 70, 78 during assembly of the housing 10. To secure the drive-side component 54 to the inlet-side component 58, the flanges 70, 78 can be crimped in multiple locations around the housing 10 as is well known in the art. Alternatively, the flanges 70, 78 can be fastened using conventional releasable or permanent fasteners, or can be snap-fitted together via suitable inter-engaging features on the drive-side and inlet-side components 54, 58. As another alternative, the flanges 70, 78 can be welded or brazed together. The mating flanges 70, 78 can further provide a mounting flange 86 for the fan housing 10, such that the fan housing 10 can be directly connected to associated equipment (e.g., a furnace), adjacent framework, a wall, and the like without using a separate mounting bracket or other fixture. If desired, multiple apertures 90 can be provided through the mounting flange(s) 86 to provide mounting locations for the fan housing 10, such as for screws, bolts, rivets, nails, or other fasteners secured to an adjacent structure.

With continued reference to the exemplary illustrated embodiment, and more particularly to FIG. 6, the portion of the side wall 30 defined by the inlet-side component 58 near the cutoff 42 of the housing 10 (i.e., at the front of the housing 10) fills the void left by the lack of a portion of the side wall 30 defined by the drive-side component 54 in this area. With this construction of the housing 10, the mounting flange 86 can be located on or near the bottom-most surface of the housing 10 while still providing for a housing design having drive-side and inlet-side components 54, 58 manufactured from sheet metal using a conventional process, such as stamping. By removing a portion of the side wall 30 from the drive-side component 54 and replacing it with a portion of the side wall 30 defined by the inlet-side component 58, both drive-side and inlet-side components 54, 58 can be more easily manufactured by a number of different conventional processes.

For example, it can be highly desirable to manufacture the housing 10 illustrated in the accompanying figures from flat pieces of sheet metal using a conventional sheet metal forming process (e.g., stamping). However, if the drive-side component 54 was stamped from sheet metal to comprise the entire side wall 30 of the housing 10, conditions would exist (e.g., the need for making complex bends of the sheet metal in the vicinity of the cutoff 42) promoting unwanted and undesirable compression and tension forced in the sheet metal. Such forces can generate unacceptable bunching, pinching, crimping, folding, or turning of the sheet metal, such as in the vicinity of the cutoff 42. To avoid this result, conventional wisdom indicates that a compromise in housing geometry would be required or that extensive process steps are necessary to address these manufacturing problems. Also according to conventional wisdom, the performance or cost disadvantages in either case would present challenges to the effectiveness and viability of such a design. However, by employing the housing and side wall structure of the present invention as described above, these problems are avoided.

Also, it should be noted that both drive-side and inlet-side components 54, 58 are together responsible for the performance of the fan. Together, these components 54, 58 are able to produce a level of performance comparable to conventional fan housing designs of similar dimensional properties in which the fan housing 10 is manufactured in other manners (e.g., molded or cast).

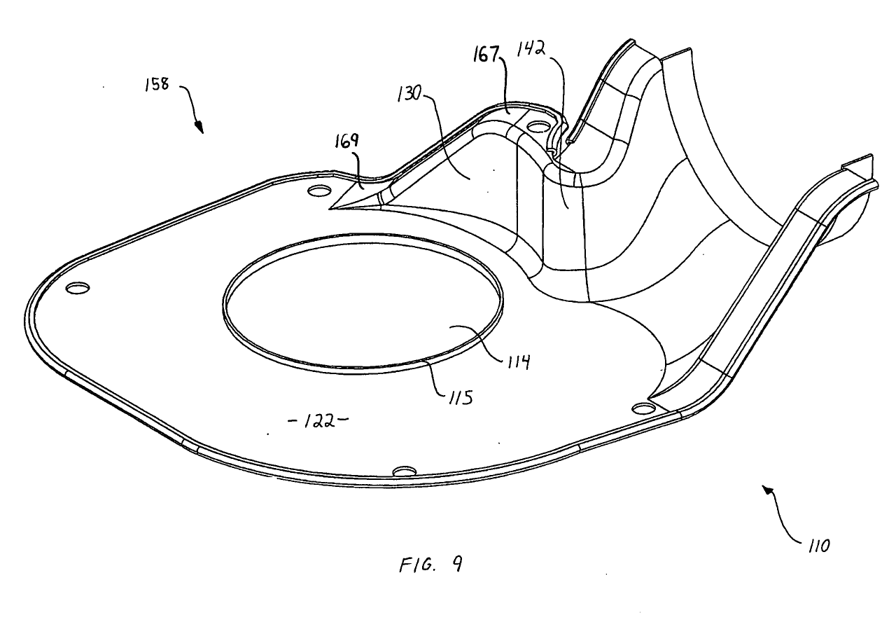

FIG. 9 illustrates an alternative inlet-side component 158 according to the present invention. The inlet-side component 158 shown in FIG. 9 can be employed in the housing 10 illustrated in FIGS. 1-8 or in conjunction with any of the other housing embodiments described above. The inlet-side component 158 shown in FIG. 9 is similar in many ways to the inlet side component 58 described above. Accordingly, with the exception of mutually inconsistent features and elements between the inlet-side component embodiments of FIGS. 1-8 and FIG. 9, reference is hereby made to the description above accompanying the embodiment of FIGS. 1-8 for a more complete description of the features and elements (and the alternatives to the features and elements) of the inlet-side component embodiment of FIG. 9. Features and elements of the inlet-side component of FIG. 9 corresponding to features and elements of the embodiment of FIGS. 1-8 are numbered in the 100 series.

In some cases, fluid (e.g., air, gases, etc.) drawn into the intake port 14, 114 of the housing 10, 110 can be recirculated in the housing 10, 110. For example, fluid can enter in a generally axial direction into the housing 10, 110, can move in radially outward directions within the housing 10, 110, and in some cases can then move in radially inward directions between the fan (not shown) and the bottom wall 122 of the housing 10, 110. The radially inward movement of fluid between the fan and the bottom wall 122 of the housing 10, 110 is the result of a lower pressure at the inlet stream during operation of the fan, and can be detrimental to overall fan performance. Such fluid recirculation can be prevented or reduced by a barrier located at or adjacent the intake port 114 to block fluid from returning axially toward the intake port 114 between the bottom wall 122 and the fan.

For this purpose, an intake wall 115 extends from the perimeter of the intake port 114 in a direction into the interior of the fan housing 110. This intake wall 115 can extend axially as shown, and in some embodiments can also extend in a radially inward or radially outward direction as the intake wall 115 extends into the interior of the fan housing 110. The intake wall 115 can improve performance of a fan housing 110 employing other fan housing features and elements described above with reference to FIGS. 1-8. The intake wall 115 illustrated in FIG. 9 extends entirely around the intake port 114, although in some alternate embodiments the intake wall 115 extends around less than the entire intake port 114. Also, the intake wall 115 can be defined by a single ring-shaped structure as shown in FIG. 9, or can instead be defined by multiple elements that together define such a structure. Although a continuous and unbroken intake wall 115 performs well to reduce fluid recirculation in the fan housing 110 as described above, the intake wall 115 can have one or more gaps as desired.

The intake wall 115 can be located at the edge of the bottom wall 122 defining the intake port 114 as shown in FIG. 9. However, any portion or all of the intake wall 115 can be located a radial distance from the intake port 114. Also, the intake wall 115 can have a uniform height (i.e., dimension in an axial direction of the fan housing 110) as shown in FIG. 9, or can have a varying height about the intake port 114. In some embodiments, the height of the intake wall 115 is selected based at least in part upon the distance between the fan (not shown) and the bottom wall 122 of the fan housing 110. The intake wall 115 can extend axially to a location short of the fan. However, in other embodiments, the intake wall 115 extends across the entire gap or substantially the entire gap between the fan and the bottom wall 122. In still other embodiments, the intake wall 115 can extend in an axial direction at least partially into a central open area of the fan. In those cases where the intake wall 115 extends to the fan and/or into the fan, the intake wall 115 can be radially smaller than a radially innermost dimension of the fan, thereby providing a radial clearance between the intake wall 115 and the inside of the fan.

In some embodiments, the intake wall 115 is between about 0.03 and about 0.25 inches in height. However, the inventors have discovered that a wall height of between about 0.03 and about 0.13 inches can provide better performance results. The inventors have also discovered that a wall height of about 0.06 can provide still better performance results. Still other wall heights are possible and fall within the spirit and scope of the present invention.

The intake wall 115 can extend around the intake port 114 to define any shape desired. In some embodiments, the intake wall 115 has the same or similar shape as the intake port 114, although in other embodiments, the intake wall 115 takes other shapes (in which case any portion or all of the intake wall 115 can be located away from the edge of the bottom wall 122 defining the intake port 114 as described above).

The intake wall 115 can be produced in a number of different manners. In some embodiments, significant cost savings are achieved by forming the intake wall 115 integrally with the bottom wall 122. For example, the intake wall 115 can be formed in the same manner as one or more of the other features (e.g., cutoff 142, side wall 130, and the like) of the inlet-side component 158, such as by one or more stamping operations. In the illustrated exemplary embodiment of FIG. 9, the intake wall 115 is formed by embossing the material of the bottom wall 122 about the intake port 114. In other embodiments, an integral intake wall 115 can be formed by a wiping operation in which the material at the edge of the bottom wall 122 defining the intake port 114 is wiped by a blade or other tool to form an intake wall 115 as shown in FIG. 9. In still other embodiments, an integral intake wall 115 can be formed by molding, drawing, extruding, pressing, or other operations performed upon the material of the bottom wall 122 adjacent the intake port 114.

Although an integral intake wall 115 can present significant manufacturing advantages, the intake wall 115 can instead be a separate element attached to the bottom wall 122 of the inlet-side component 158 in any suitable manner, such as by one or more fasteners passed through apertures in the bottom wall 122 and the intake wall 115, by adhesive or cohesive bonding material, by welding or brazing, by snap-fit or other inter-engaging elements or features on the bottom wall 122 and the intake wall 115, by a threaded connection between the intake wall 115 and the bottom wall 122, and the like.

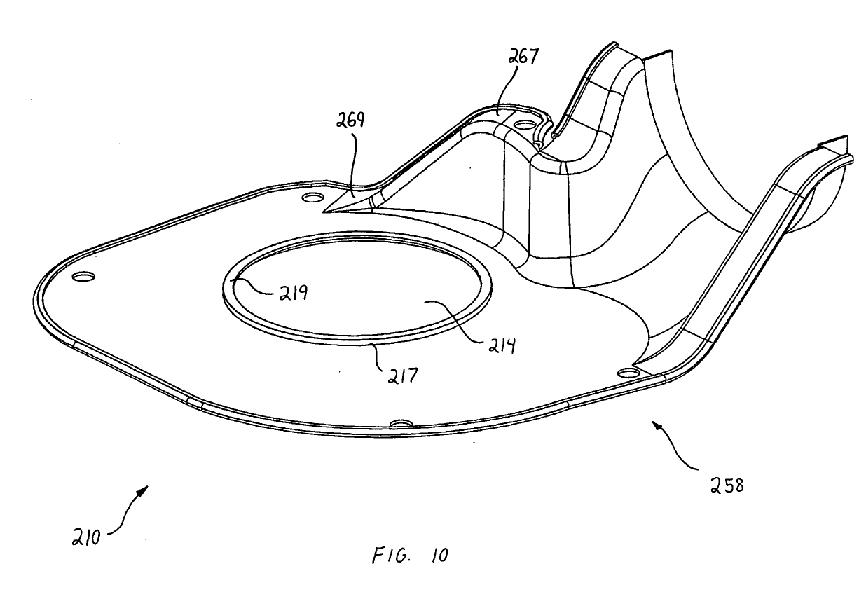

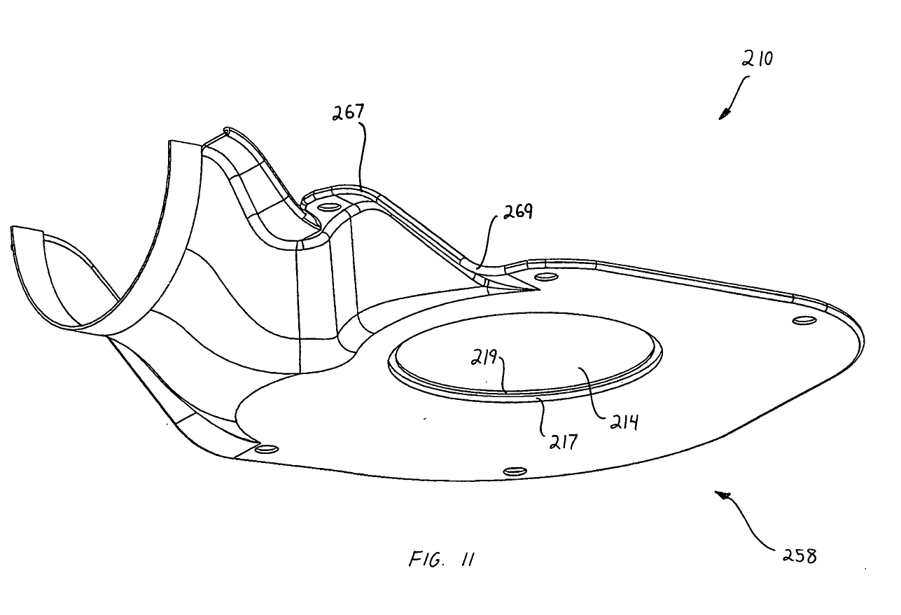

FIGS. 10 and 11 illustrate another alternative inlet-side component 258 according to the present invention. The inlet-side component 258 shown in FIGS. 10 and 11 can be employed in any housing 10 illustrated in FIGS. 1-8 or in conjunction with any of the other housing embodiments described above. The inlet-side component 258 shown in FIGS. 10 and 11 is similar in many ways to the inlet side component 158 described above with reference to FIG. 9. Accordingly, with the exception of mutually inconsistent features and elements between the inlet-side component embodiments of FIG. 9 and FIGS. 10 and 11, reference is hereby made to the description above accompanying the embodiment of FIG. 9 for a more complete description of the features and elements (and the alternatives to the features and elements) of the inlet-side component embodiment of FIGS. 10 and 11. Features and elements of the inlet-side component of FIGS. 10 and 11 corresponding to features and elements of the embodiment of FIG. 9 are numbered in the 200 series.

In some cases, the inventors have discovered that it is desirable to restrict the size of the intake port 214 of the fan housing 210. For example, certain pressure and flow capabilities of the housing 210 can be achieved by restricting the intake port 214, and can provide benefits (e.g., increased efficiency of a connected furnace or other connected equipment) specific to various applications.

With reference to FIGS. 10 and 11, an intake wall 217 is located adjacent the intake port 214 of the inlet-side component 258. This intake wall 217 extends axially into the interior of the fan housing 210, and can take any of the forms and shapes described above with reference to the inlet-side component 158 of FIG. 9. However, the intake wall 217 also has a portion 219 that extends radially inwardly to define a restriction of the intake port 214. In some embodiments, this portion 219 of the intake wall 217 extends radially inwardly between about 0.03 and about 0.25 inches. However, the inventors have discovered that an intake wall portion 219 that extends radially inwardly between about 0.03 and about 0.13 inches can provide better performance results. The inventors have also discovered that an intake wall portion 219 that extends radially inwardly about 0.06 inches can provide still better performance results. Intake wall portions 219 having still other radially-extending dimensions are possible and fall within the spirit and scope of the present invention.

The intake wall 217 (and portion 219 thereof) can be produced in any of the manners described above with reference to the inlet-side component 158 of FIG. 9. In the illustrated embodiment of FIGS. 10 and 11, an integrally-formed intake wall 217 can provide manufacturing advantages over non-integral intake walls 217.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention.

We claim:

1. A fan housing for a fan rotatable about an axis, the fan housing comprising:
a first housing component at least partially defining
an internal chamber adapted to receive the fan; and
an inlet wall having an inlet aperture through which fluid enters the fan housing;
the first housing component comprising
a transition section extending away from the inlet aperture toward an exhaust outlet and through which fluid passes from the internal chamber to the exhaust outlet;
an axially-extending side wall located adjacent the exhaust outlet; and
a wall integrally formed with the inlet wall, running around the inlet aperture, and extending generally axially into the internal chamber;
a second housing component complementary to the first housing component and at least partially defining the internal chamber, the second housing component comprising
a transition section extending toward the exhaust outlet and through which fluid passes from the internal chamber to the exhaust outlet; and
a side wall extending axially toward the first housing component and shaped complementary to the axially-extending side wall of the first housing component; and
a housing seam defined between the side wall of the first housing component and the side wall of the second housing component, the seam having a length extending at least partially about the axis while extending axially.

2. The fan housing as claimed in claim 1, wherein the wall integrally formed with the inlet wall has a portion extending radially inwardly to at least partially define an inlet restriction of the fan housing.

3. The fan housing as claimed in claim 2, wherein the wall integrally formed with the inlet wall 30 extends axially into the fan.

4. The fan housing as claimed in claim 1, further comprising:
a cutoff located adjacent the exhaust outlet and defining high and low pressure areas at different circumferential positions about the axis; wherein
the seam runs about the axis from one side of the exhaust outlet to another side of the exhaust outlet; and
the cutoff is located between the exhaust outlet and the length of the seam extending at least partially about the axis while extending axially.

5. The fan housing as claimed in claim 1, wherein the seam extends from an axial location substantially co-planar with the inlet wall to an axial location disposed from the inlet wall.

6. The fan housing as claimed in claim 1, wherein:
the second housing component further comprises a wall spaced a distance from the inlet wall to at least partially define the internal chamber; and
the seam extends from an axial location substantially co-planar with the wall of the second housing component to an axial location disposed from the wall of the second housing component.

7. The fan housing as claimed in claim 1, wherein:
the side wall is substantially volute, and extends between a location adjacent one side of the exhaust outlet to a location adjacent another side of the outlet; and
the length of the seam extending at least partially about the axis while extending axially is located adjacent the exhaust outlet.

8. The fan housing as claimed in claim 7, wherein:
the length of the seam extends about less than a majority of the circumference of the side walls; and
another length of the seam extends about another portion of the circumference of the side walls.

9. The fan housing as claimed in claim 1, wherein the length of the seam extending at least partially about the axis while extending axially runs in a direction away from the inlet wall with increasing proximity to the exhaust outlet.

10. The fan housing as claimed in claim 1, wherein each of the first and second housing components has a flange, the flanges of the first and second housing components defining the housing seam therebetween.

11. The fan housing as claimed in claim 4, wherein the side wall of the second housing component extends about the axis and ends a distance short of the cutoff.

12. The fan housing as claimed in claim 1, wherein:
fluid flow through the fan housing includes a flow path extending from a location upstream of the transition sections to the exhaust outlet;
a first plane in which the axis lies extends through portions of the first and second housing components at a location upstream of the first and second transition sections to define a substantially rectangular cross-sectional shape; and
a second plane substantially perpendicular to flow toward the exhaust outlet extends through the first and second transition sections to define a substantially round cross-sectional shape.

13. The fan housing as claimed in claim 1, wherein the exhaust outlet at least a part of the first and second transition sections are axially displaced with respect to the rest of the fan housing.

14. The fan housing as claimed in claim 1, wherein the first housing component includes a axially-extending wall adjacent the inlet aperture.

15. The fan housing as claimed in claim 13 wherein the axially-extending wall is an annular wall extending axially into the internal chamber.

16. A two-piece fan housing for receiving a fan rotatable about an axis, the two-piece fan housing comprising:
a first housing piece comprising:
a first wall;
an inlet aperture defined in the first wall through which fluid enters the fan housing; and
a transition section extending to and partially defining an exhaust outlet of the fan housing through which fluid exits the fan housing;
a second housing piece shaped complementary to the first housing piece and comprising:
a second wall spaced from the first wall; and
a transition section extending to and partially defining the exhaust outlet;
a side wall extending about the axis between the first and second walls of the first and second housing pieces, the side wall comprising an axial length between the first and second walls, at least a majority of the axial length of the side wall adjacent to the exhaust outlet defined by the first housing piece, and at least a majority of the axial length of the side wall in other locations around the axis defined by the second housing piece; and
a seam defined between adjacent portions of the first and second housing pieces, the seam running about the axis, comprising a first portion running partially about the axis while also running in an axial direction, and further comprising a second portion lying within a plane substantially perpendicular to the axis, wherein the first and second portions of the seam are joined by an axially-curved third portion of the seam integral with the first and second portions.

17. The two-piece fan housing as claimed in claim 16, wherein the axial length of the side wall is substantially constant in a majority of locations about the axis.

18. The two-piece fan housing as claimed in claim 16, wherein the plane is a first plane, and wherein the seam further comprises a fourth portion lying within a plane substantially perpendicular to the axis and spaced an axial distance from the first plane.

19. The two-piece fan housing as claimed in claim 18, wherein the first and fourth portions of the seam are joined by an axially-curved fifth portion of the seam integral with the first and fourth portions.

20. The two-piece fan housing as claimed in claim 16, wherein the first portion of the seam extends at least ⅛ way around the fan housing.

21. The two-piece fan housing as claimed in claim 16, wherein the first portion of the seam extends at least ⅓ way around the fan housing.

22. The two-piece fan housing as claimed in claim 16, further comprising flanges extending radially away from the seam at the first, second, and third portions of the seam, wherein the flanges at the second and third portions of the seam are curved.

23. The two-piece fan housing as claimed in claim 16, further comprising a wall integrally formed with the first wall, running around the inlet aperture, and extending in a generally axial direction.

24. The two-piece fan housing as claimed in claim 23, wherein the wall integrally formed with the first wall has a portion extending radially inwardly to at least partially define an inlet restriction of the fan housing.

25. The two-piece fan housing as claimed in claim 24, wherein the wall integrally formed with the first wall extends axially into the fan.

26. The two-piece fan housing as claimed in claim 16, further comprising:
a cutoff located adjacent the exhaust outlet and defining high and low pressure areas at different circumferential positions about the axis; wherein
the seam runs about the axis from one side of the exhaust outlet to another side of the exhaust outlet; and
the cutoff is located between the exhaust outlet and the first portion of the seam.

27. The fan housing as claimed in claim 16, wherein:
the side wall is substantially volute, and extends between a location adjacent one side of the exhaust outlet to a location adjacent another side of the outlet; and
the length of the first portion of the seam is located adjacent the exhaust outlet.

28. A method of manufacturing a two-piece fan housing for receiving a fan rotatable about an axis, the method comprising:
forming a first wall from a first substantially flat sheet of material;
forming an inlet aperture in the first wall;
forming an axially-extending inlet wall from the first substantially flat sheet of material, the axially-extending inlet wall running about the inlet aperture;
forming a first transition section from the first substantially flat sheet of material, the first transition section extending to and partially defining an exhaust outlet of the fan housing;
forming a first portion of a volute housing side wall from the first substantially flat sheet of material;
forming a second wall from a second substantially flat sheet of material;
forming a second transition section from the second substantially flat sheet of material, the second transition section extending to and partially defining the exhaust outlet;
forming a second portion of a volute housing side wall from the second substantially flat sheet of material, the second portion of the volute side wall having a shape complementary to the first portion of the volute housing side wall; and
coupling the first and second portions of the volute housing side wall together along a seam that extends axially while also extending circumferentially.

29. The method as claimed in claim 28, wherein the first and second flat sheets of material are sheet metal.

30. The method as claimed in claim 28, wherein:
the side wall has an axial length;
at least a majority of the axial length of the side wall adjacent the exhaust outlet is defined by the first portion of the volute side wall; and
at least a majority of the axial length of the side wall in other locations around the axis defined by the second portion of the volute side wall.
